(19) United States
(12) Patent Application Publication
(10) Pub. No.: US 2017/0339571 A1
(43) Pub. Date: Nov. 23, 2017

(54) BASE STATION AND TERMINAL DEVICE

(71) Applicant: NEC Corporation, Minato-ku, Tokyo (JP)

(72) Inventor: Takahiro TSUTSUI, Tokyo (JP)

(73) Assignee: NEC Corporation, Minato-ku, Tokyo (JP)

(21) Appl. No.: 15/529,172

(22) PCT Filed: Dec. 10, 2015
(86) PCT No.: PCT/JP2015/006159

§ 371 Date: May 24, 2017

(30) Foreign Application Priority Data
Dec. 11, 2014 (JP) 2014-250456

(51) Int. Cl. H04W 16/18; H04W 16/32; H04W 4/00; H04W 24/10; H04W 88/02; H04W 88/08

(52) U.S. Cl. CPC H04W 16/18; H04W 16/32; H04W 4/005; H04W 88/02; H04W 88/08; H04W 24/10

(57) ABSTRACT

A base station for determining the status of overlap between cells without imposing unnecessary loads on a device that determines the status of overlap between the cells or on a terminal device has a first cell. The base station comprises a reception unit that receives information related to a second cell, from a first terminal device that communicates with the base station and that satisfies a condition related to the type of terminal device. The base station also comprises a determination unit that determines, on the basis of the information transmitted from the first terminal device, the status of overlap between the coverage range of the first cell and the coverage range of the second cell.

### TECHNICAL FIELD

The present disclosure relates to a base station and a terminal device.

### BACKGROUND ART

In recent years, a network system using cells having various coverage ranges in combination has been proposed. Examples of the network system include a Heterogeneous Network (also referred to as Het Net), which is formed by a macro cell having a broad coverage range with a radius of about several kilometers, and a pico cell, a small cell, or the like having a coverage range with a radius of about several ten meters arranged within the macro cell. In the Heterogeneous Network, the macro cell and the small cell are arranged in a manner at least partially overlapping with each other geographically.

In such a cellular communication system, since a new cell may be unexpectedly disposed in an area where a cell is disposed, it is necessary to grasp a status of overlap between cells.

For example, PTL 1 discloses a method of detecting the reception intensity of transmission radio waves received in one mobile station from each base station and determining, on the basis of the detected reception intensity, overlap between cells that virtually causes an adverse effect on communication quality by means of a centralized control station.

### CITATION LIST

### Patent Literature

[PTL 1] Japanese Unexamined Patent Application Publication No. 2008-42736

### SUMMARY OF INVENTION

### Technical Problem

However, in the method disclosed in PTL 1, a device determining a status of overlap between cells receives information related to the reception intensity from all terminal devices existing in a coverage range of a cell.

Thus, the device determining a status of overlap between cells requires a large amount of time for processing the information, which causes a problem of a heavy load on the device. In addition, even when, for example, it is required to collect information from one hundred terminal devices in order to grasp a status of overlap between cells, the information is collected from eight hundred terminal devices, which causes a problem of imposing unnecessary loads on seven hundred terminal devices.

In view of the above, one object to be accomplished by example embodiments disclosed herein is to provide a device, a method, a program and the like that can determine a status of overlap between cells without imposing an unnecessary load on a terminal device or a device determining a status of overlap between cells.

### Solution to Problem

A base station according to the example embodiment, has a first cell, and comprises: a reception unit that receives information related to a second cell from a first terminal device that communicates with the base station and satisfies a condition related to a type of a terminal device; and a determination unit that determines, based on the information transmitted from the first terminal device, a status of overlap between a coverage range of the first cell and a coverage range of the second cell.

A terminal device according to the example embodiment, communicates with a base station having a first cell, and comprises: a determination unit that determines whether or not the terminal device is a terminal device that satisfies a condition related to a type of a terminal device; and a transmission unit that, when the terminal device is a terminal device that satisfies the condition, transmits information related to a second cell to the base station.

### Advantageous Effects of Invention

The example embodiments described above enable determination of a status of overlap between cells without imposing an unnecessary load on a terminal device or a device determining a status of overlap between cells.

### BRIEF DESCRIPTION OF DRAWINGS

FIG. 1 is a configuration diagram of a communication system according to a first example embodiment.

FIG. 2 is a block diagram of a base station according to the first example embodiment.

FIG. 3 is a diagram illustrating an example of an overlap relation between a coverage range of a first cell and a coverage range of a second cell.

FIG. 4 is a diagram illustrating an example of an overlap relation between a coverage range of a first cell and a coverage range of a second cell.

FIG. 5 is a block diagram of a terminal device according to the first example embodiment.

FIG. 6 is a flowchart of an operation of the base station according to the first example embodiment.

FIG. 7 is a flowchart of an operation of the terminal device according to the first example embodiment.

FIG. 8 is a block diagram of a base station according to a second example embodiment.

FIG. 9 is a block diagram of a terminal device according to the second example embodiment.

FIG. 10 is a flowchart of an operation of the base station according to the second example embodiment.

FIG. 11 is a flowchart of an operation of the terminal device according to the second example embodiment.

FIG. 12 is a configuration diagram of a communication system according to a third example embodiment.

FIG. 13 is a block diagram of a base station according to the third example embodiment.

FIG. 14 is a block diagram of a terminal device according to the third example embodiment.

FIG. 15 is a flowchart of an operation of the base station according to the third example embodiment.

FIG. 16 is a flowchart of an operation of the terminal device according to the third example embodiment.

FIG. 17 is a sequence diagram according to the third example embodiment.

FIG. 18 is a sequence diagram according to the third example embodiment.

FIG. 19 is a configuration diagram of a communication system according to a fourth example embodiment.

FIG. 20 is a block diagram of a base station according to the fourth example embodiment.

FIG. 21 is an example of a first cell divided into a plurality of zones.

FIG. 22 is an example of a cell detection list according to the fourth example embodiment.

FIG. 23 is an example of a cell detection list according to the fourth example embodiment.

FIG. 24 is a sequence diagram of a determination unit according to the fourth example embodiment.

FIG. 25 is a sequence diagram of a determination unit according to the fourth example embodiment.

FIG. 26 is a block diagram of the communication system according to each of the example embodiments.

### EXAMPLE EMBODIMENT

In the following, example embodiments will be specifically described in detail with reference to the drawings. Throughout the drawings, the same or corresponding elements are assigned with the same reference numerals, and redundant description therefor will be omitted as needed for clarification of illustration.

A plurality of example embodiments described below can be carried out independently, and can be carried out in combination as appropriate. The plurality of example embodiments have mutually different novel features. Thus, the plurality of example embodiments contribute to solving mutually different objects or problems, and contribute to exhibiting mutually different advantageous effects.

### First Example Embodiment

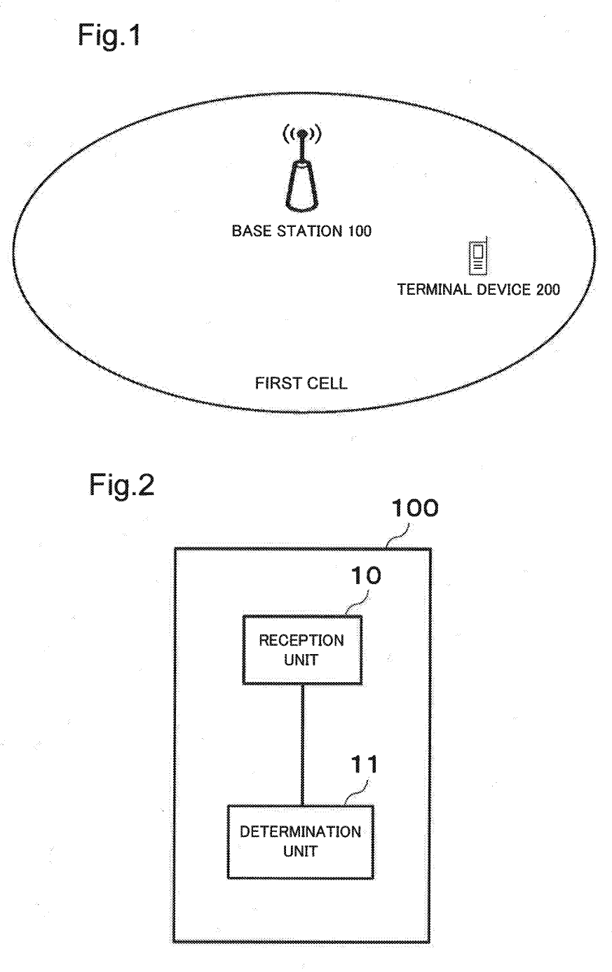

FIG. 1 illustrates a configuration example of a wireless communication system according to a first example embodiment. The wireless communication system provides a communication service, for example, voice communication or packet data communication, or both of voice communication and packet data communication. Referring to FIG. 1, the wireless communication system includes a base station 100, a first cell covered by the base station 100, and a terminal device 200 communicating with the base station 100. In addition, a second cell is present besides the first cell, although not illustrated in FIG. 1. The second cell may be any form, as long as the second cell is different from the first cell. For example, the second cell may be in a geographical positional relation in which a coverage range of the first cell and a coverage range of the second cell partially overlap with each other. Alternatively, for example, the second cell may be in a geographical positional relation in which a coverage range of the first cell is included in a coverage range of the second cell. Note that a base station covering the second cell may be the base station 100, or may be another base station.

FIG. 2 illustrates an example of a configuration of the base station 100 according to the first example embodiment.

The base station 100 includes at least a reception unit 10 and a determination unit 11.

The reception unit 10 is connected with an external device wiredly or wirelessly, and transmits and receives various kinds of information to and from the external device. In the present example embodiment, the reception unit 10 receives information related to a second cell from a terminal device that communicates with a base station and satisfies a condition related to a type of a terminal device.

Herein, a condition related to a type of a terminal device may be information indicating a specific terminal device. For example, the condition related to a type of a terminal device may be a condition that a terminal device is a Machine Type Communication (MTC) terminal device, and may be a condition that a terminal device is a terminal device whose battery remaining amount is equal to or greater than a predetermined value (or equal to or less than a predetermined value). In addition, the condition related to a type of a terminal device may be a condition that a terminal device is a terminal device existing at a cell edge of a first cell, and may be a condition that a terminal device is a terminal device existing beside a road. In addition, the condition related to a type of a terminal device may be a condition related to a User Equipment State (UE State). The condition related to a UE State is, for example, a condition that indicates whether a terminal device is a terminal device in a RADIO RESOURCE CONTROL Idle (RRC Idle) state or a terminal device in a RADIO RESOURCE CONTROL Connected (RRC Connected) state. In addition, the condition related to a type of a terminal device may be any one of the conditions listed above, or may be a condition combining a plurality of conditions. For example, the condition related to a type of a terminal device may be a condition that a terminal device is a MTC terminal device and a terminal device whose UE state is a RRC Connected state.

In addition, information related to a second cell may include information related to the quality of a second cell. The information related to the quality of a second cell may be, for example, a downlink channel quality indicator (CQI), and may be a downlink Reference Signal Received Power (RSRP).

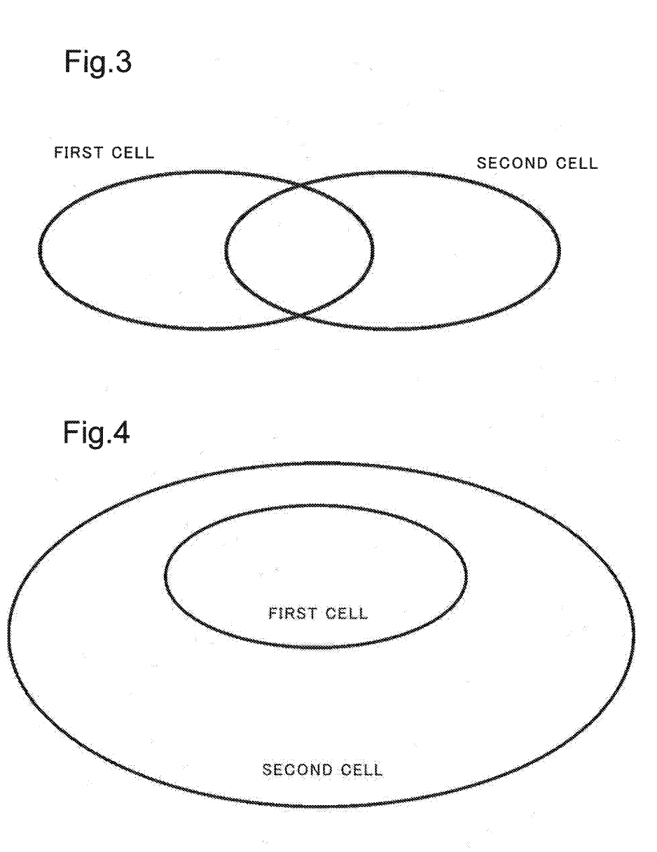

The determination unit 11 determines, on the basis of information related to a second cell received by the reception unit 10, a status of overlap between a coverage range of a first cell and a coverage range of the second cell. FIGS. 3 and 4 illustrate examples of a status of overlap between a coverage range of a first cell and a coverage range of a second cell determined by the determination unit 11. FIG. 3 illustrates a status in which a coverage range of a first cell and a coverage range of a second cell partially overlap with each other. FIG. 4 illustrates a status in which a coverage range of a first cell is included in a coverage range of a second cell.

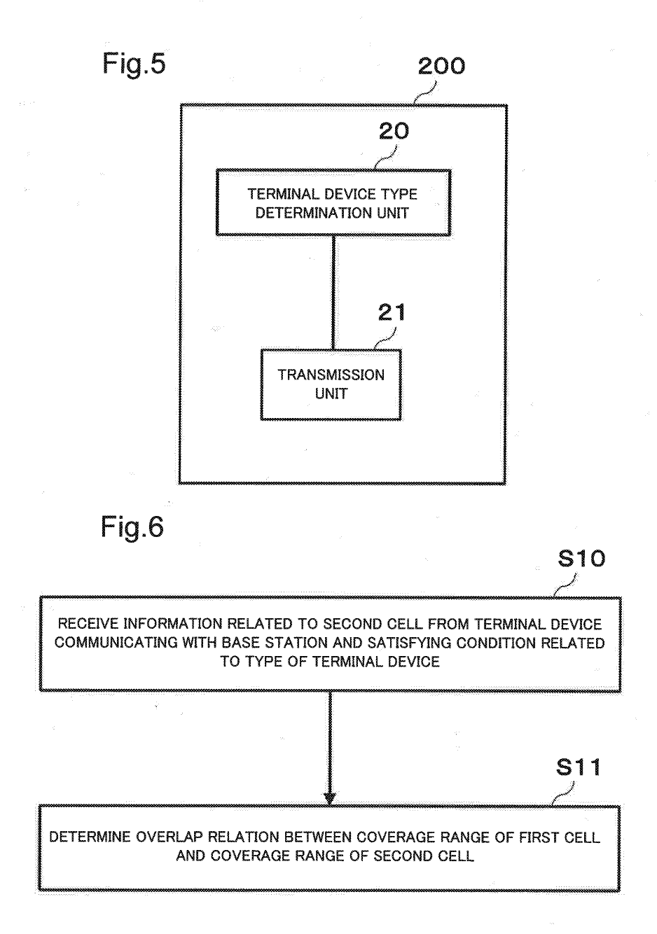

FIG. 5 illustrates an example of a configuration of the terminal device 200 according to the first example embodiment.

The terminal device 200 includes at least a terminal device type determination unit 20 and a transmission unit 21.

The terminal device type determination unit 20 determines whether or not a terminal device is a terminal device that satisfies a condition related to a type of a terminal device. Note that the condition related to a type of a terminal device may be stored in a terminal device in advance, and may be provided from an external device such as a base station.

The transmission unit 21, when the terminal device is a terminal device that satisfies the condition related to a type of a terminal device as a result of determination made by the terminal device type determination unit 20, transmits information related to a second cell to the base station 100.

Next, an operation of the base station 100 according to the present example embodiment will be described with use of FIG. 6.

At Step S10, the reception unit 10 receives information related to a second cell from a terminal device that communicates with the own station and satisfies a condition related to a type of a terminal device.

At Step S11, the determination unit 11 determines, on the basis of the information related to a second cell received by the reception unit 10, a status of overlap between a coverage range of a first cell and a coverage range of the second cell.

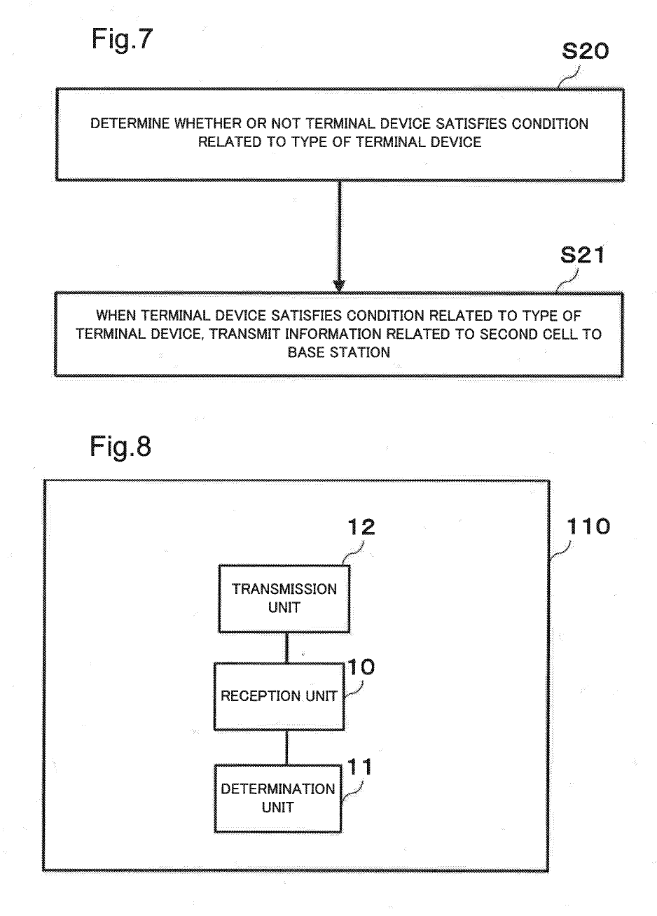

FIG. 7 illustrates an example of an operation of the terminal device 200 according to the present example embodiment.

At Step S20, the terminal device type determination unit 20 determines whether or not the terminal device is a terminal device that satisfies a condition related to a type of a terminal device.

At Step S21, when the terminal device is a terminal device that satisfies a condition related to a type of a terminal device as a result of determination made by the terminal device type determination unit 20, the transmission unit 21 transmits information related to a second cell to the base station 100.

In a manner as described above, the base station 100 according to the present example embodiment determines a status of overlap between a coverage range of a first cell and a coverage range of a second cell, on the basis of information related to the second cell received from a terminal device that communicates with the base station 100 and satisfies a condition related to a type of a terminal device. Accordingly, a load required for the determination can be significantly reduced.

### Second Example Embodiment

In a second example embodiment, a modification example of the above-described first example embodiment will be described.

FIG. 8 illustrates an example of a configuration of a base station 110 according to the second example embodiment.

The base station 110 includes at least a reception unit 10, a determination unit 11, and a transmission unit 12. The reception unit 10 and the determination unit 11 are the same as in the first example embodiment.

The transmission unit 12 broadcasts broadcast information to a terminal device that communicates with the base station 110. The broadcast information includes a condition related to a type of a terminal device. In addition, the broadcast information includes information instructing a terminal device that satisfies the condition related to a type of a terminal device to transmit information related to a second cell to the base station 110.

Note that the broadcast information may include information specifying a second cell. The information specifying a second cell may be, for example, a Physical Cell Identifier (PCI), an E-UTRAN Cell Global Identifier (ECGI), an E-UTRAN Cell Identifier (ECI), and a Primary Scrambling Code (PSC) of a second cell. In a case in which a plurality of cells exist in the neighborhood of a first cell, broadcast information including the information specifying a second cell allows a base station to acquire only desired information.

In addition, the broadcast information may include information or the like related to a quality report regulation. The information related to a quality report regulation is information limiting the number of terminal devices that transmit information related to a second cell to the base station 110. For example, the information related to a quality report regulation may indicate that the number of terminal devices that transmit information related to a second cell to the base station 110 is set to half, as compared with the number of terminal devices in a case in which broadcast information does not include the information related to a quality report regulation. Specifically, for example, assume that there are one hundred terminal devices that satisfy a condition related to a type of a terminal device. When the information related to a quality report regulation indicates a value of 50%, the number of terminal devices that transmit information related to a second cell to the base station 110 is set to fifty. An advantageous effect of adding the information related to a quality report regulation to broadcast information is as follows. For example, when there are many terminal devices that satisfy a condition related to a type of a terminal device and the base station 110 receives information related to a second cell from many terminal devices, a Physical Resource Block (PRB) usage rate, a Central Processing Unit (CPU) usage rate of the base station 110, and the like rise. As a result, there arises a possibility of reduction in Quality of Experience (QoE) of a terminal device performing normal voice communication and data communication. Setting a quality report regulation enables limitation on the number of terminal devices that transmit information related to a second cell to the base station 110, which can prevent the problem described above.

In addition, the broadcast information may include information related to an expiration period of the broadcast information. The information related to an expiration period indicates until when each piece of information included in the broadcast information is valid. For example, in a case in which the information related to an expiration period indicates a certain time, a terminal device having received broadcast information determines whether or not a time at which the broadcast information is received (hereinafter, referred to as a reception time) is after a time indicated by the information related to an expiration period (hereinafter, referred to as an expiration period time). When the reception time is not after the expiration period time, the terminal device performs operation in accordance with each piece of information included in the broadcast information. On the other hand, when the reception time is after the expiration period time, the terminal device discards the broadcast information. An advantageous effect of adding the information related to an expiration period to broadcast information is as follows. For example, there is a possibility that a terminal device may transmit information related to a second cell to the base station 110 in a period after determination is performed by the determination unit 11 of the base station 110 and before next determination is performed. In this case, since the information related to a second cell transmitted by the terminal device is not to be used for determination of the determination unit 11, the terminal device results in transmitting useless information to the base station 110. Broadcast information including the information related to an expiration period allows for preventing a terminal device to transmit useless information to the base station 110.

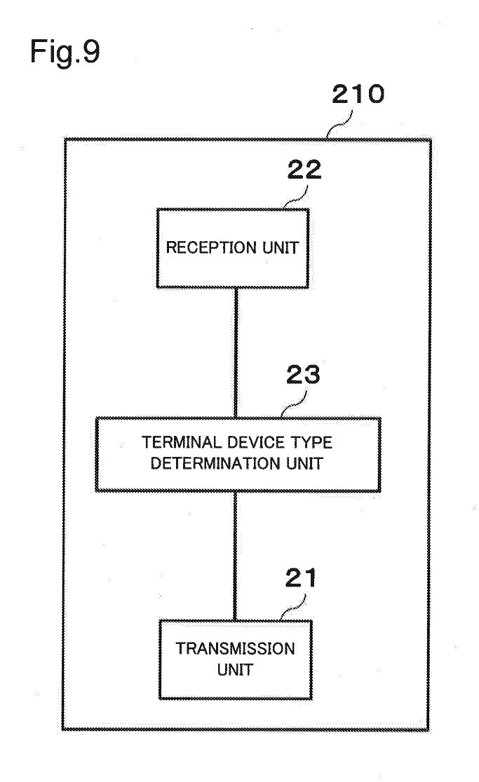

FIG. 9 illustrates an example of a configuration of a terminal device 210 according to the second example embodiment.

The terminal device 210 includes at least a terminal device type determination unit 23, a transmission unit 21, and a reception unit 22. The transmission unit 21 is the same as in the first example embodiment.

The reception unit 22 receives broadcast information from the base station 110 that communicates with the terminal device. The broadcast information includes a condition related to a type of a terminal device. In addition, the broadcast information includes information instructing a terminal device that satisfies the condition related to a type of a terminal device to transmit information related to a second cell to the base station 110.

The terminal device type determination unit 23 determines, on the basis of a condition related to a type of a terminal device included in broadcast information received by the reception unit 22, whether or not the terminal device is a terminal device that satisfies the condition related to a type of a terminal device.

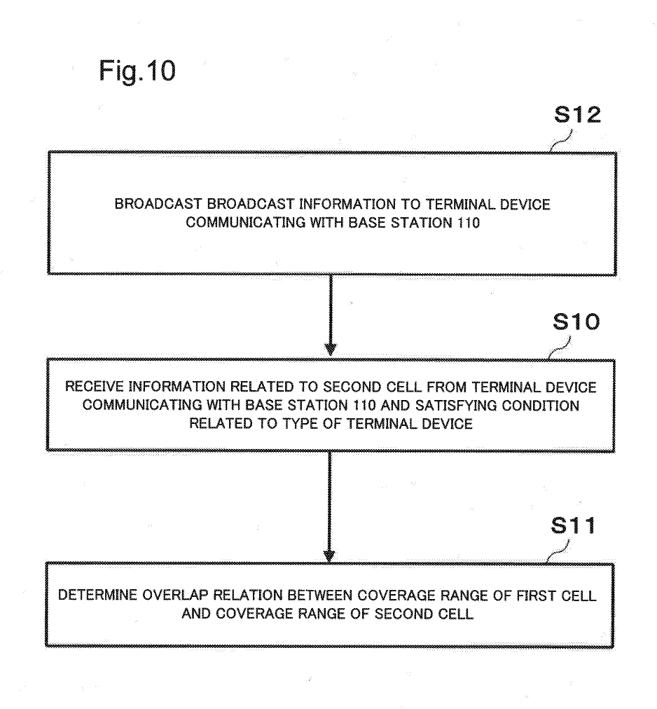

Next, an operation of the base station 110 according to the present example embodiment will be described with use of FIG. 10.

At Step S12, the transmission unit 12 broadcasts broadcast information to a terminal device that communicates with the base station 110. The broadcast information includes a condition related to a type of a terminal device. In addition, the broadcast information includes information instructing a terminal device that satisfies the condition related to a type of a terminal device to transmit information related to a second cell to the base station 110.

Steps S10 and S11 are the same as in the first example embodiment.

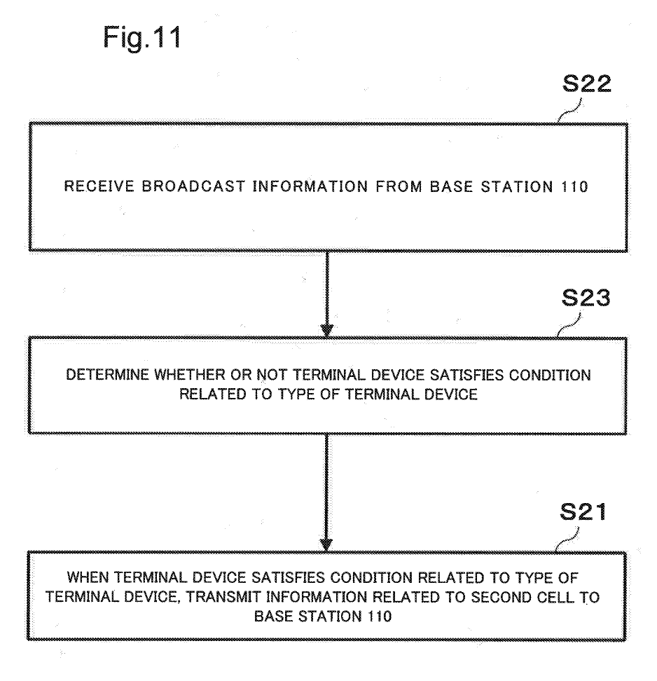

FIG. 11 illustrates an example of an operation of the terminal device 210 according to the present example embodiment.

At Step S22, the reception unit 22 receives broadcast information from the base station 110 that communicates with the terminal device. The broadcast information includes a condition related to a type of a terminal device. In addition, the broadcast information includes information instructing a terminal device that satisfies the condition related to a type of a terminal device to transmit information related to a second cell to the base station 110.

At Step S23, the terminal device type determination unit 23 determines, on the basis of the condition related to a type of a terminal device included in the broadcast information received by the reception unit 22, whether or not the terminal device is a terminal device that satisfies the condition related to a type of a terminal device.

Step S21 is the same as in the first example embodiment.

The communication system or the base station according to the present example embodiment can solve a problem as follows. Automatic Neighbour Relation (ANR) is one of approaches for collecting information related to another cell. In the ANR, however, since a report from a terminal device is used as a trigger, the information related to another cell cannot be acquired with arbitrary timing. As another approach, there is an approach for giving an instruction to a terminal device from a communication device such as a base station. For example, as means for giving an instruction from a base station to a terminal device for reporting information related to another cell, there are a method of giving an instruction to only a particular terminal device, and a method of giving an instruction to all terminal devices within a cell by means of broadcast information. In the former method, a base station is required to specify to which terminal device the base station gives an instruction and then give an instruction to an individual terminal device, which may possibly increase a load on the base station. In addition, in the later method, since all terminal devices capable of receiving the broadcast information are to be affected, it is not possible to cause only a part of the terminal devices to report information related to another cell.

The present example embodiment makes it possible to cause only a terminal device that satisfies a condition related to a type of a terminal device included in broadcast information to transmit information related to another cell. Accordingly, loads on a base station and an overall communication system can be reduced.

### Third Example Embodiment

In a third example embodiment, a modification example of the above-described first or second example embodiment will be described.

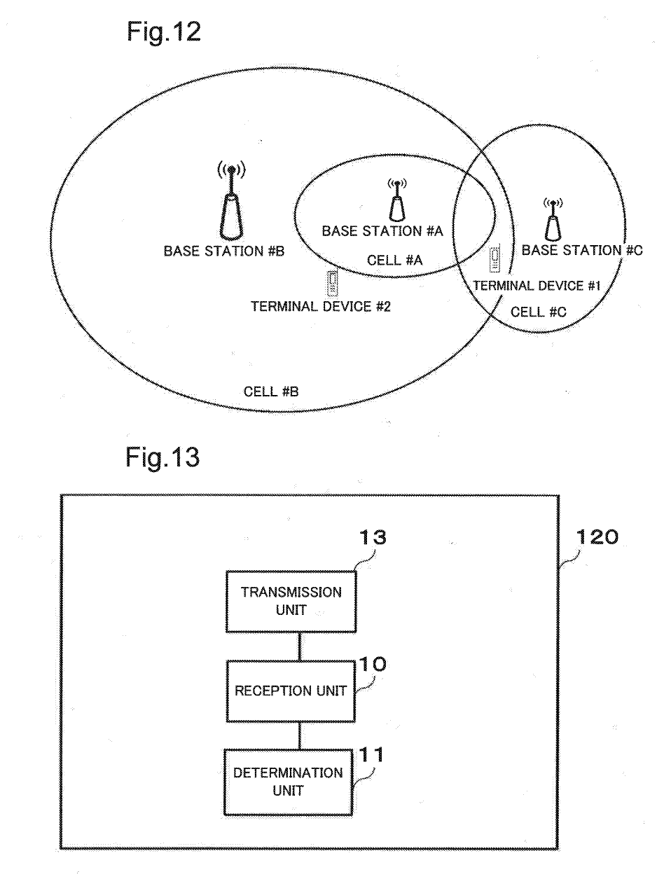

FIG. 12 illustrates a configuration example of a wireless communication system according to the third example embodiment. Referring to FIG. 12, the wireless communication system includes a base station #A, a cell #A covered by the base station #A, a base station #B, a cell #B covered by the base station #B, a base station #C, a cell #C covered by the base station #C, a terminal device #1 communicating with the base station #C, and a terminal device #2 communicating with the base station #B. A coverage range of the cell #A is included in a coverage range of the cell #B, and in addition, the coverage range of the cell #A and a coverage range of the cell #C partially overlap with each other. Hereinafter, the base station #A is also represented as a base station 120, and the terminal device #1 is also represented as a terminal device 220. Note that the first cell in the first and second example embodiments corresponds to the cell #A, and the second cell in the first and second example embodiments corresponds to the cell #B or cell #C.

FIG. 13 illustrates an example of a configuration of the base station 120 according to the third example embodiment.

The base station 120 includes at least a reception unit 10, a determination unit 11, and a transmission unit 13. The reception unit 10 and the determination unit 11 are the same as in the first example embodiment.

The transmission unit 13 transmits, to a base station covering a cell adjacent to the cell #A, a condition related to a type of a terminal device and information for causing a terminal device that satisfies the condition related to a type of a terminal device to be camped on the cell #A. In the present example embodiment, a cell adjacent to the cell #A is the cell #B and the cell #C. In addition, a base station covering a cell adjacent to the cell #A is the base station #B and the base station #C.

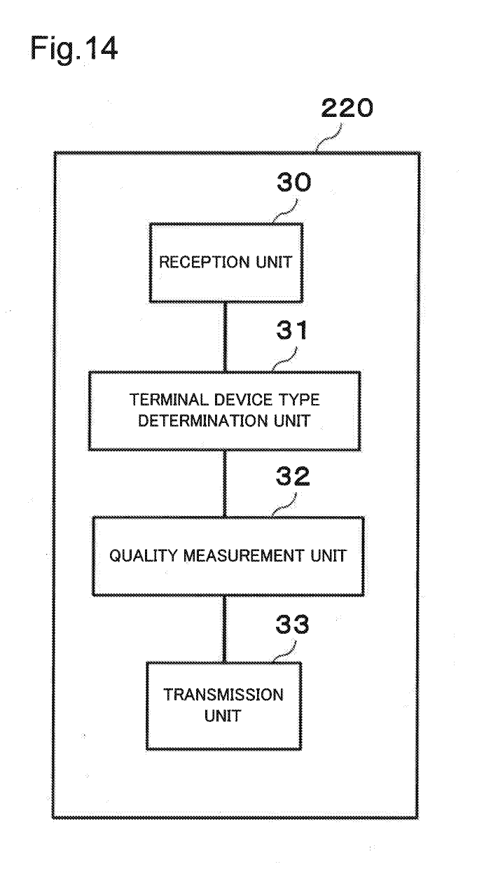

FIG. 14 illustrates an example of a configuration of the terminal device 220 according to the third example embodiment.

The terminal device 220 includes at least a reception unit 30, a terminal device type determination unit 31, a quality measurement unit 32, and a transmission unit 33.

The reception unit 30 receives, from a base station communicating with the terminal device, broadcast information including a condition related to a type of a terminal device and information related to a cell to camp on when the own terminal device station is a terminal device that satisfies the condition related to a type of a terminal device. Herein, a base station communicating with a terminal device is the base station #C for the terminal device #1, and is the base station #B for the terminal device #2. In addition, the reception unit 30 also has a function of the reception unit 22 described in the first example embodiment and the second example embodiment. In other words, the reception unit 30 receives, from a base station communicating with the terminal device, broadcast information including a condition related to a type of a terminal device and information instructing a terminal device that satisfies the condition related to a type of a terminal device to transmit information related to a second cell to the base station. Note that the second cell is a cell adjacent to the cell #A (for example, the cell #C).

The terminal device type determination unit 31 determines, on the basis of a condition related to a type of a terminal device included in broadcast information received by the reception unit 30, whether or not the terminal device is a terminal device that satisfies the condition related to a type of a terminal device. Further, when the terminal device is a terminal device that satisfies the condition related to a type of a terminal device, the terminal device is camped on a cell to camp on, on the basis of information related to a cell to camp on included in broadcast information received by the reception unit 30. For example, when the information related to a cell to camp on is information instructing for camping on the cell #A, the terminal device #1 is camped on the cell #A from the cell #C. Note that, in a case in which the terminal device #1 is camped on the cell #A, the terminal device #1 measures the quality of the cell #A, and, when a measurement result is a predetermined value or less, the terminal device #1 may not be necessarily camped. The predetermined value may be included in information that the base station #A transmits to the base station #B and the base station #C, and may be also included in broadcast information that the base station #B and the base station #C broadcast.

In the following, description will be given on the premise that camping on the cell #A is performed as an example.

The quality measurement unit 32 measures, on the basis of broadcast information received by the reception unit 30 from the base station #A after camping on the cell #A is performed, the quality of a cell (for example, the cell #C) adjacent to the cell #A. Note that the broadcast information broadcasted from the base station #A may include information specifying a second cell. For example, when the information specifying a second cell is information indicating the cell #C, the quality measurement unit 32 measures the quality of the cell #C.

The transmission unit 33 transmits information related to the quality of a cell measured by the quality measurement unit 32 to the base station #A. Note that the transmission unit 33 transmits the information related to the quality to the terminal device #1 after the terminal device #1 transitions from an RRC Idle state to an RRC Connected state with respect to the cell #A.

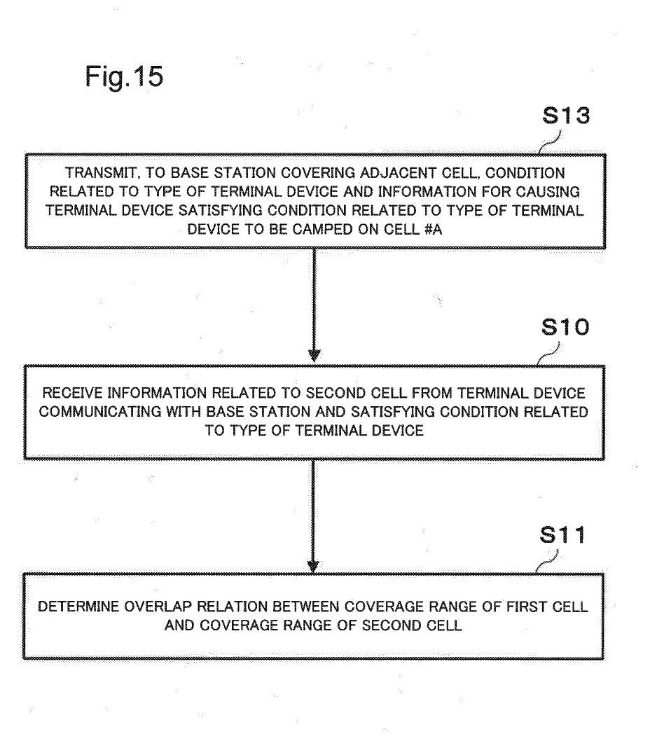

Next, an operation of the base station 120 according to the third example embodiment will be described with use of FIG. 15.

At Step S13, the second transmission unit 13 transmits, to a base station covering a cell adjacent to the cell #A, a condition related to a type of a terminal device and information for causing a terminal device that satisfies the condition related to a type of a terminal device to be camped on the cell #A.

Steps S10 and S11 are the same as in the first example embodiment.

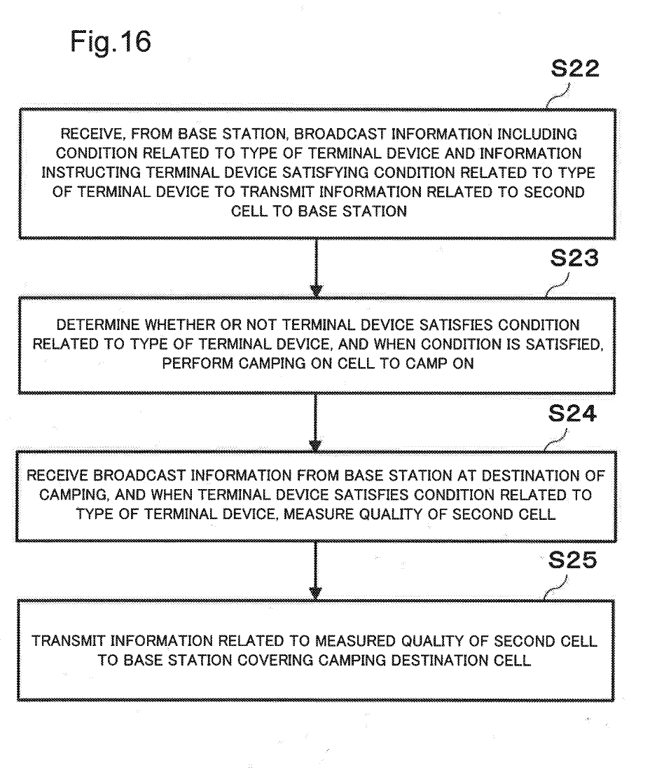

FIG. 16 illustrates an example of an operation of the terminal device 220 according to the third example embodiment.

At Step S22, the reception unit 30 receives, from a base station (in this case, the base station #B or the base station #C) communicating with the terminal device, broadcast information including a condition related to a type of a terminal device and information related to a cell to camp on when a terminal device is a terminal device that satisfies the condition related to a type of a terminal device.

At Step S23, the terminal device type determination unit 31 determines, on the basis of the condition related to a type of a terminal device included in the broadcast information received by the reception unit 30, whether or not the terminal device is a terminal device that satisfies the condition related to a type of a terminal device. Further, when the terminal device is a terminal device that satisfies the condition related to a type of a terminal device, the terminal device is camped on a cell to camp on (in this case, the cell #A), on the basis of the information related to a cell to camp on included in the broadcast information.

At Step S24, the reception unit 30 receives broadcast information from a base station (in this case, the base station #A) communicating with the terminal device. The broadcast information includes a condition related to a type of a terminal device and information instructing a terminal device that satisfies the condition related to a type of a terminal device to transmit information related to a second cell to the base station. Note that the second cell is a cell (for example, the cell #C) adjacent to the cell #A.

In addition, at Step S24, the quality measurement unit 32 measures the quality of the second cell, on the basis of the broadcast information received by the reception unit 30 from the base station #A after camping on the cell #A is performed.

At Step S25, the transmission unit 33 transmits, to the base station #A, information related to the quality of the second cell measured by the quality measurement unit 32. In transmitting the information, the transmission unit 33 transmits the information related to the quality after first transitioning from an RRC Idle state to an RRC Connected state with respect to the camping cell #A.

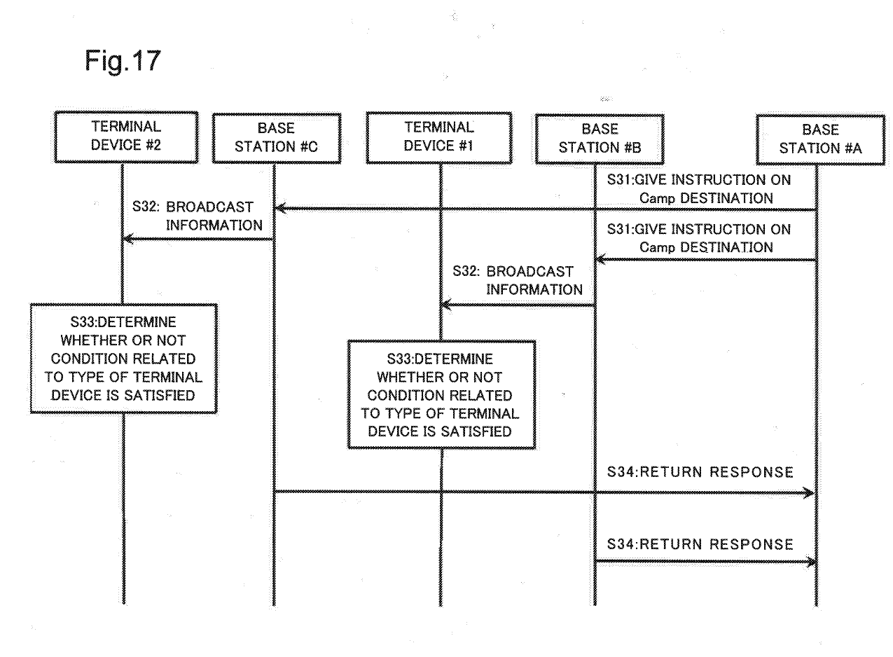

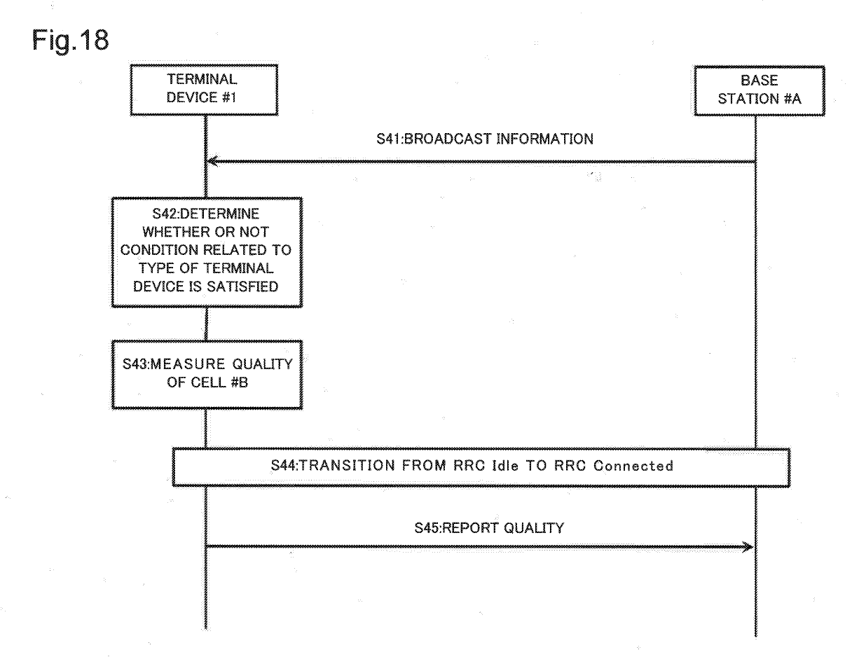

Next, an operation of the communication system according to the third example embodiment will be described with use of FIGS. 17 and 18.

At Step S31, the base station #A transmits, to the base station #B and the base station #C that are base stations covering cells adjacent to the cell #A, a condition related to a type of a terminal device and information for causing a terminal device that satisfies the condition related to a type of a terminal device to be camped on the cell #A.

At Step S32, the base station #B and the base station #C broadcast, on the basis of the information received from the base station #A, broadcast information including, incorporated therein, a condition related to a type of a terminal device and information for causing a terminal device that satisfies the condition related to a type of a terminal device to be camped on the cell #A.

At Step S33, the terminal device #1 and the terminal device #2 having received the broadcast information broadcasted from the base station #B and the base station #C determine whether or not the terminal device satisfies the condition related to a type of a terminal device included in the broadcast information. When the terminal device is a terminal device that satisfies the condition related to a type of a terminal device, the terminal device is camped on a cell to camp on (in this case, cell #A), on the basis of the information related to a cell to camp on included in the received broadcast information. For example, when the terminal device #1 satisfies the condition related to a type of a terminal device yet the terminal device #2 does not satisfy the condition related to a type of a terminal device, only the terminal device #1 is camped on the cell #A. In this case, the terminal device #2 continues communication with the base station #B.

At Step S34, the base station #B and the base station #C return a response to the base station #A in order to report that the base station #B and the base station #C have broadcasted broadcast information.

At Step S41, the base station #A broadcasts broadcast information including a condition related to a type of a terminal device and information instructing a terminal device that satisfies the condition related to a type of a terminal device to transmit information related to a cell that is in an overlap relation with a coverage range of the cell #A to the base station.

At Step S42, the terminal device #1 determines whether or not the terminal device satisfies the condition related to a type of a terminal device included in the broadcast information.

At Step S43, the terminal device #1 measures, on the basis of the broadcast information received by the reception unit 30 from the base station #A after camping on the cell #A is performed, the quality of a cell (for example, the cell #B and the cell #C) that is in an overlap relation with the coverage range of the cell #A.

At Step S44, the terminal device #1 transmits information related to the quality of the cell measured by the quality measurement unit 32 to the base station #A. Note that the terminal device #1 transmits the information related to the quality to the base station #A (Step S45) after transitioning from an RRC Idle state to an RRC Connected state with respect to the cell #A.

In addition, in the present example embodiment, description is given assuming that the base station #A is a base station covering only the cell #A. However, the base station #A may be a base station covering a plurality of cells. For example, in FIG. 12, the communication system may be such that the base station #A covers the cell #B and the cell #C.

In this case, the base station #A transmits, to the base station #B and the base station #C, information related to a type of a terminal device and information for causing a terminal device that satisfies the condition related to a type of a terminal device to be camped on the cell #A. This transmission process may be replaced with a process in which the base station #A broadcasts the information as broadcast information to the cell #B and the cell #C.

The communication system and the base station according to the present example embodiment can solve a problem as follows. When there are a small number of terminal devices that exist within a coverage range of a first cell and satisfy a condition related to a type of a terminal device, there arises a possibility that a base station may be unable to accurately grasp a status of overlap between the coverage range of the first cell and a coverage range of a second cell.

The present example embodiment makes it possible to increase the number of terminal devices that exist within a coverage range of a first cell and satisfy a condition related to a type of a terminal device, by causing a terminal device that satisfies the condition related to a type of a terminal device to camp from a cell adjacent to the first cell.

### Fourth Example Embodiment

In a fourth example embodiment, an example of a configuration and an operation of the discrimination unit according to the above-described first through third example embodiments will be described in a further specified manner.

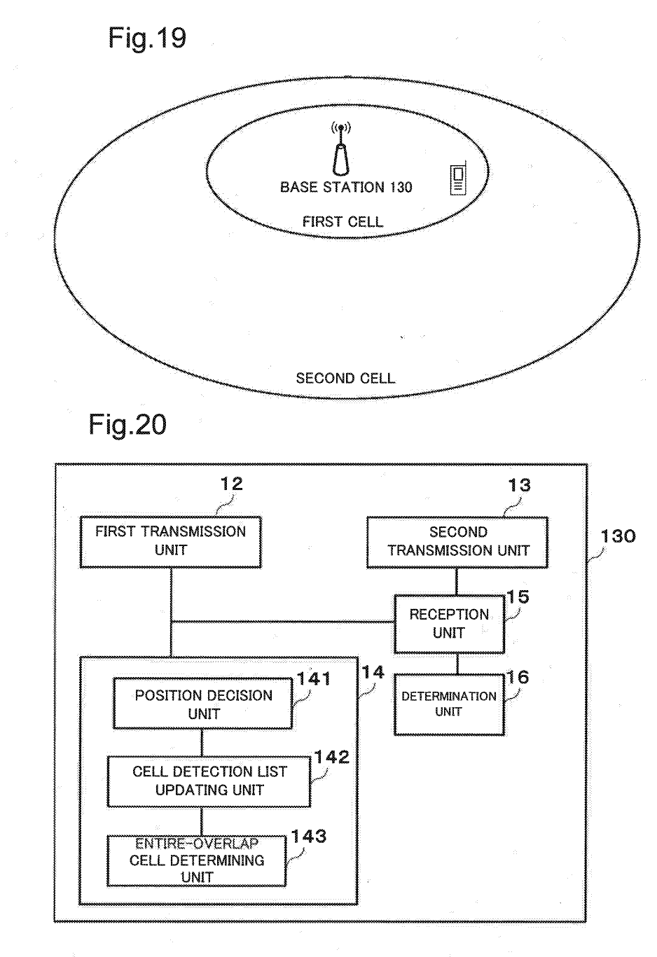

FIG. 19 illustrates a configuration example of a wireless communication system according to the fourth example embodiment. Referring to FIG. 19, the wireless communication system includes a base station 130, a first cell covered by the base station 130, and a terminal device communicating with the base station 130.

FIG. 20 illustrates an example of a configuration of the base station 130 according to the fourth example embodiment.

The base station 130 includes at least a first transmission unit 12, a second transmission unit 13, a control unit 14, a reception unit 15, and a determination unit 16. The first transmission unit 12 and the second transmission unit 13 are the same as the transmission unit 12 described in the second example embodiment and the transmission unit 13 described in the third example embodiment, respectively.

The control unit 14 further includes a position decision unit 141, a cell detection list updating unit 142, and an entire-overlap cell determining unit 143.

The position decision unit 141 decides the position of a terminal device having transmitted a Measurement Report received by the reception unit 15.

The cell detection list updating unit 142 updates a cell detection list.

The entire-overlap cell determining unit 143 determines whether there is a possibility of being an entire-overlap cell.

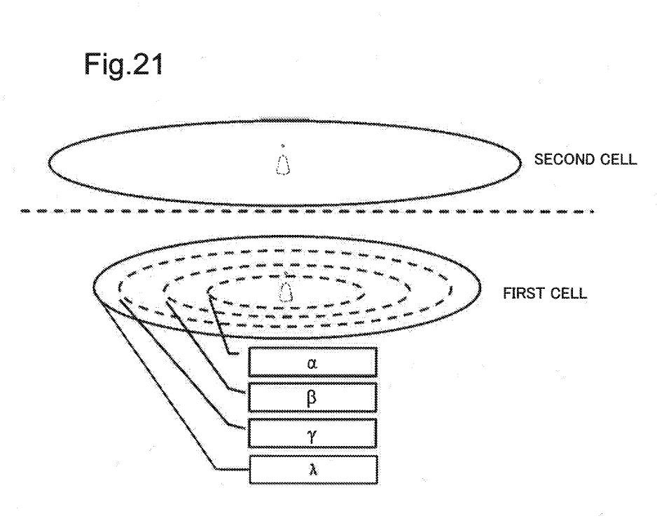

First, a method of deciding the position of a terminal device will be described in detail. The position decision unit 141 decides, on the basis of information related to the quality of a first cell included in a Measurement Report received by the reception unit 15, how far the position where a terminal device having transmitted the Measurement Report exists is from the first cell. Specifically, the position decision unit 141 divides the first cell into a plurality of zones in accordance with a distance from the center point, and then decides in which zone a terminal device exists. As an example, FIG. 21 illustrates a positional relation among zones when the first cell is divided into four zones in accordance with a distance from the center point. FIG. 21 illustrates a positional relation among zones when the first cell is divided into a zone to a distance α from the center point of the first cell, a zone from the distance α to a distance β from the center point of the first cell, a zone from the distance β to a distance γ from the center point of the first cell, and a zone from the distance γ to a distance λ from the center point of the first cell.

Note that the information related to the quality of a first cell may be a CQI and an RSRP.

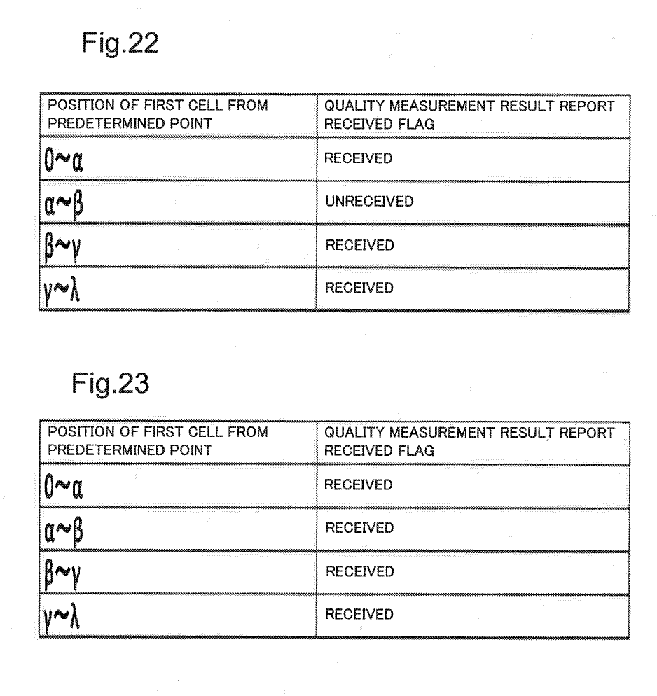

Next, updating of a cell detection list will be described in detail with use of FIGS. 22 and 23.

FIGS. 22 and 23 both illustrate examples of a cell detection list. A cell detection list is created for each combination of the own cell and another cell. In the present example embodiment, since the first cell and the second cell are present, one cell detection list is created with a combination of the first cell and the second cell. For a communication system in which a third cell is present besides the second cell, still another cell detection list is created with a combination of the first cell and the third cell.

When information included in a Measurement Report received by the reception unit 15 is information related to the quality of the second cell and a terminal device having transmitted the Measurement Report exists in the zone from the distance α to the distance β from the center point of the first cell, “Quality Measurement Result Report Received Flag” in a column whose “Position of First Cell from Predetermined Point” is “α to β” in a cell detection list is updated from “Unreceived” to “Received”. FIG. 22 illustrates a cell detection list before the updating is performed, and FIG. 23 illustrates a cell detection list after the updating is performed.

Next, determination whether or not there is a possibility of being an entire-overlap cell will be described in detail. The entire-overlap cell means another cell in a relation in which the own cell is included in the other cell. In FIG. 19, the coverage range of the first cell is included in the coverage range of the second cell. The second cell for the first cell is a cell overlapping with an entire coverage range of the own cell. In the present example embodiment, a second cell in such a situation is referred to as an entire-overlap cell. The entire-overlap cell determining unit 143 determines whether or not there is a possibility that a second cell is deemed as an entire-overlap cell for a first cell.

The reception unit 15 receives a Measurement Report including information related to an adjacent cell from a terminal device communicating with the own station. In addition, the reception unit 15 also performs the same operation as that of the reception unit described in the first through third example embodiments.

The determination unit 16 also performs the same operation as that of the determination unit described in the first through third example embodiments. More specifically describing, the determination unit 16 performs the following three operations. First, the determination unit 16 determines whether or not the number of quality reports related to a second cell is greater than a first threshold value. When the number of quality reports related to a second cell is less than the first threshold value, the determination unit 16 determines that an information amount is insufficient for making determination of an entire-overlap cell, and does not perform a subsequent determination operation. Next, the determination unit 16 counts a quality report value indicating a value that exceeds a second threshold value among the quality reports related to a second cell. For example, assume that a base station receives five quality reports, and values of the respective quality reports are a, b, c, d, and e (a>b>c>d>e). When the second threshold value is d, the number of reports (in this case, 3) indicating quality report values (a, b, and c) greater than the second threshold value is set as the number of quality reports. Next, the determination unit 16 compares a value obtained by dividing the number of quality reports (in the aforementioned example, 3) by a total number of quality reports (in the aforementioned example, 5) with a third threshold value. When the value obtained by dividing the quality reports by a total number of quality reports is greater than the third threshold value, the determination unit 16 determines that a second cell is an entire-overlap cell for a first cell.

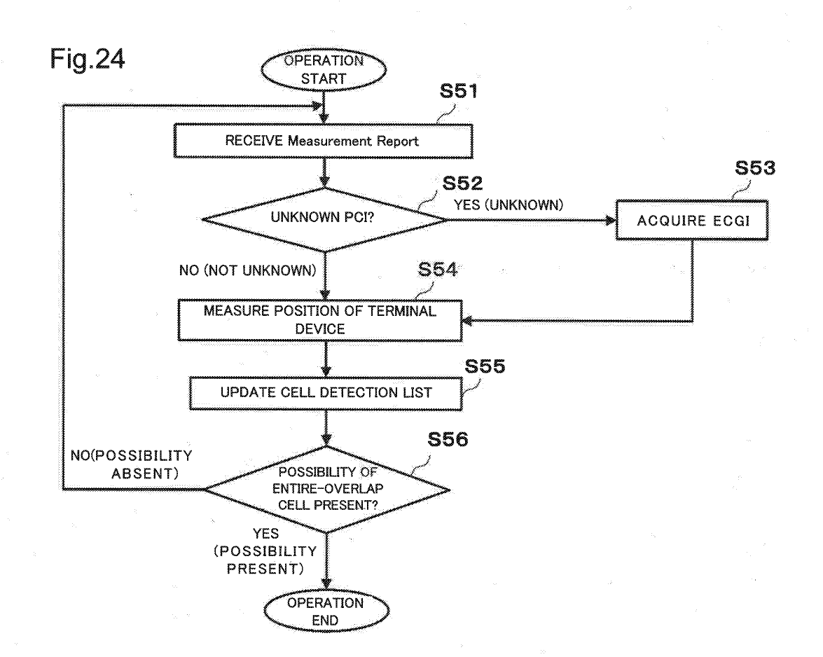

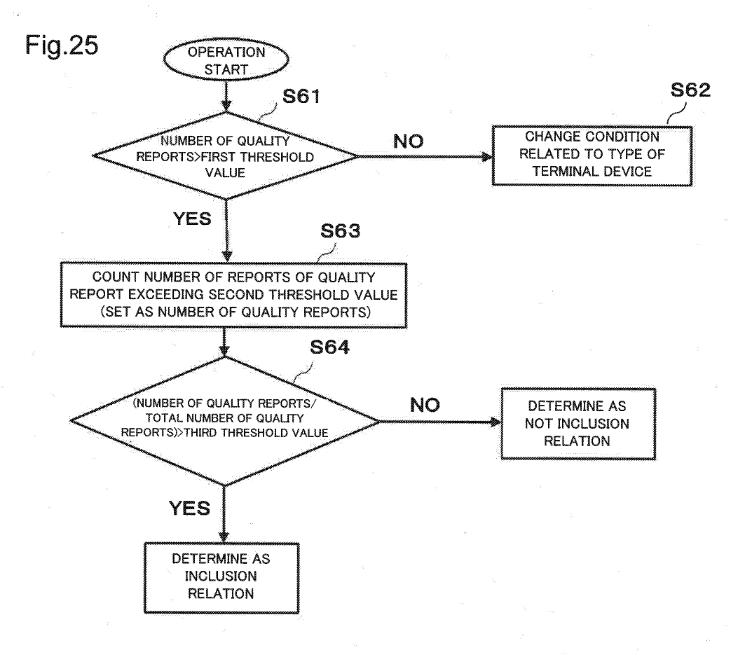

Next, an operation of the base station 130 according to the present example embodiment will be described with use of FIGS. 24 and 25.

FIG. 24 illustrates an operation of the control unit 14.

At Step S51, the control unit 14 controls reception processing of receiving a Measurement Report from a terminal device communicating with the own station.

At Step S52, the control unit 14 determines whether or not a PCI included in the received Measurement Report is an unknown PCI. When the PCI is an unknown PCI (S52: Yes), the processing proceeds to S53. When the PCI is not an unknown PCI (S52: No), the processing proceeds to S54.

At Step S53, the control unit 14 gives an instruction to the terminal device having transmitted the Measurement Report to report an ECGI of a cell having the PCI, and acquires an ECGI corresponding to the unknown PCI from a report of the terminal device having received the instruction.

At Step S54, the position decision unit 141 measures the position of the terminal device having transmitted the Measurement Report.

At Step S55, the cell detection list updating unit 142 updates a cell detection list.

At Step S56, the entire-overlap cell determining unit 143 determines, on the basis of the updated cell detection list, whether or not there is a possibility of being an entire-overlap cell. When there is a possibility of being an entire-overlap cell (S56: Yes), the entire-overlap cell determining unit 143 instructs the first transmission unit 12 to broadcast broadcast information including information specifying a cell having a possibility of being an entire-overlap cell. When there is no possibility of being an entire-overlap cell (S56: No), the processing returns to S51.

FIG. 25 illustrates an operation of the determination unit 16.

At Step S61, the determination unit 16 determines whether or not the number of quality reports related to a second cell is greater than the first threshold value. When the number of quality reports related to a second cell is not greater than a first threshold value (when NO at S61), the determination unit 16 changes a condition related to a type of a terminal device, and broadcasts broadcast information including the modified condition related to a type of a terminal device (Step S62).

When the number of quality reports related to a second cell is greater than a first threshold value (when YES at S61), the determination unit 16 counts a value of a quality report exceeding a second threshold value among the quality reports related to a second cell (Step S63).

At Step S64, the determination unit 16 determines whether or not a value obtained by dividing the count value by the number of quality reports is greater than a third threshold value. When a value obtained by dividing the count value by the number of quality reports is greater than the third threshold value (S64: Yes), the determination unit 16 determines that a third cell is included in a second cell. On the other hand, when a value obtained by dividing the count value by the number of quality reports is not greater than the third threshold value (S64: No), the determination unit 16 determines that a first cell is not included in a second cell.

In a manner as described above, the base station 130 according to the present example embodiment determines a cell having a possibility of being an entire-overlap cell by means of the control unit. Accordingly, an entire-overlap cell can be detected more efficiently.

Note that there is also a possibility that a cell determined as an entire-overlap cell by the determination unit 16 may afterwards turn into a non-entire-overlap cell due to a change or the like in a coverage range in association with a transmission power change or the like. Thus, when receiving a notification of a change in a coverage range from a base station covering a cell determined as an entire-overlap cell, the base station may again determine whether or not the cell is an entire-overlap cell.

In addition, there is also a possibility that a cell once determined as an entire-overlap cell by the determination unit 16 may become a non-entire-overlap cell when a Mobility success rate of cell load distribution becomes at or less than a predetermined value after the determination as being an entire-overlap cell is made. Then, the base station may again determine whether or not the cell is an entire-overlap cell.

Note that each of the above-described example embodiments may be a cell in an E-UTRAN, a cell in CDMA2000, a cell in a GERAN, or a cell in an UTRAN.

Note that, when each of the above-described example embodiments is applied to, for example, a system including a management device 300 and a base station 140, the following configuration can be conceived.

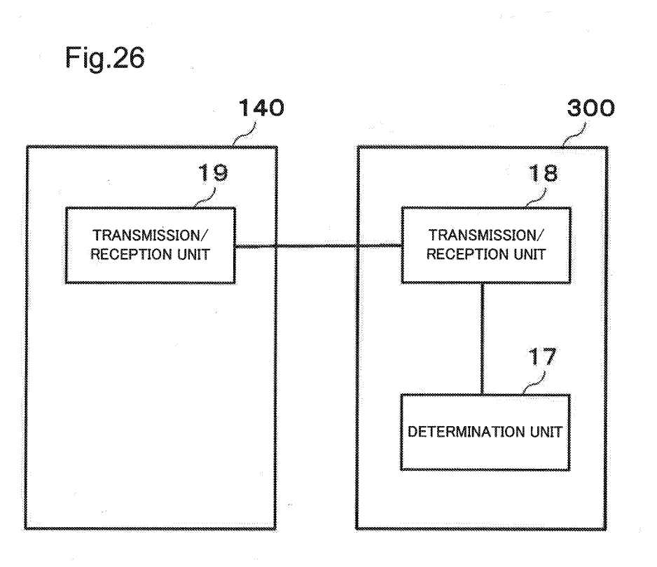

FIG. 26 illustrates a configuration example of a system including the management device 300 and the base station 140.

The management device 300 includes a determination unit 17 and a transmission/reception unit 18.

The determination unit 17 performs the same operation as that of the determination unit 11 or 16 according to each of the above-described example embodiments.

The transmission/reception unit 18 is able to perform wireless communication or wired communication with the base station 140.

The base station 140 has the configuration of the base station according to each of the above-described example embodiments except for the determination unit. Note that the base station 140 includes at least a transmission/reception unit 19.

The transmission/reception unit 19 transmits, to the management device 300, information received by the reception unit 10 according to the first example embodiment.

In a manner as described above, when each of the above-described example embodiments is applied to, for example, a system including the management device 300 and the base station 140, an overlap relation between a coverage range of a first cell and a coverage range of a second cell is determined by a management device. Accordingly, there is an advantageous effect of enabling significant reduction in a load on a base station.

A management device may be a Self-Organizing Network (SON) function server, a node management device (for example, an Element Management System (EMS) device), and the like, as long as the management device is a device that manages a base station and the like.

Each processing of the above-described example embodiments may be executed by software. In other words, a computer program for performing each processing may be read and executed by a CPU provided in a communication device. Processing of the same content as the processing of the above-described example embodiments can be performed even by using a program to perform each processing. Then, the above program may be stored in a non-transitory medium including a semiconductor memory device such as Read Only Memory (ROM), Random Access Memory (RAM), and flash memory, an optical disc, a magnetic disk, a magneto-optical disk, and the like.

The whole or part of the example embodiments disclosed above can be described as, but not limited to, the following supplementary notes.

### Supplementary Note 1

A communication system including a first cell and a second cell, a base station covering the first cell, and a terminal device communicating with the base station,

the base station including:

a reception unit that receives information related to a second cell from a terminal device that communicates with the base station and satisfies a condition related to a type of a terminal device; and

a determination unit that determines, based on the information related to the second cell, a status of overlap between a coverage range of the first cell and a coverage range of the second cell,

the terminal device including:

a terminal device type determination unit that determines whether or not a terminal device is a terminal device that satisfies the condition; and a transmission unit that, when a terminal device is a terminal device that satisfies the condition, transmits information related to a second cell to the base station.

This application is based upon and claims the benefit of priority from Japanese patent application No. 2014-250456, filed on Dec. 11, 2014, the disclosure of which is incorporated herein in its entirety by reference.

### REFERENCE SIGNS LIST

100, 110, 120, 130, 140 Base station
200, 210, 220 Terminal device
300 Management device
10, 15, 22, 30 Reception unit
11, 16, 17 Determination unit
14 Control unit
12, 13, 21, 33 Transmission unit
18 Transmission/reception unit
20, 23, 31 Terminal device type determination unit
141 Position decision unit
142 Cell detection list updating unit
143 Entire-overlap cell determining unit

What is claimed is:

1. A base station having a first cell, comprising:
a reception unit that receives information related to a second cell from a first terminal device that communicates with the base station and satisfies a condition related to a type of a terminal device; and
a determination unit that determines, based on the information transmitted from the first terminal device, a status of overlap between a coverage range of the first cell and a coverage range of the second cell.

2. The base station according to claim 1, further comprising
a first transmission unit that broadcasts, to a terminal device that communicates with the base station, broadcast information including the condition and information instructing a terminal device that satisfies the condition to transmit the information to the base station.

3. The base station according to claim 2, wherein
the broadcast information includes information specifying the second cell.

4. The base station according to claim 1, further comprising
a second transmission unit that transmits, to a base station having a cell adjacent to the first cell, information for causing a terminal device that satisfies the condition to be camped on the first cell.

5. The base station according to claim 1, wherein
the condition is a condition that a terminal device is a MTC terminal device.

6. The base station according to claim 1, wherein
the status of overlap is a relation in which the coverage range of the first cell is included in the coverage range of the second cell.

7. A terminal device communicating with a base station having a first cell, comprising:
a determination unit that determines whether or not the terminal device is a terminal device that satisfies a condition related to a type of a terminal device; and
a transmission unit that, when the terminal device is a terminal device that satisfies the condition, transmits information related to a second cell to the base station.

8. The terminal device according to claim 7, further comprising
a reception unit that receives, from the base station, broadcast information including the condition and information instructing a terminal device that satisfies the condition to transmit the information to the base station.

9. The terminal device according to claim 8, wherein the broadcast information includes information specifying the second cell.

10. The terminal device according to claim 7, wherein the condition is a condition that a terminal device is a MTC terminal device.
